(19) United States
(12) Patent Application Publication
(10) Pub. No.: US 2026/0347023 A1
(43) Pub. Date: Nov. 5, 2026

(54) Quadrotor with Control for Avoiding Inter-Rotor Interference

(71) Applicant: The Regents of The University of Michigan, Ann Arbor, MI (US)

(72) Inventors: Andrew ZHAO, Ann Arbor, MI (US); Vasileios TZOUMAS, Ann Arbor, MI (US); Atharva NAVSALKAR, Ann Arbor, MI (US); Jose DIAZ, Ann Arbor, MI (US); Jiawei XU, Ann Arbor, MI (US)

(73) Assignee: The Regents of The University of Michigan, Ann Arbor, MI (US)

(21) Appl. No.: 19/734,547

(22) Filed: Jul. 8, 2026

Related U.S. Application Data
(63) Continuation-in-part of application No. 19/345,590, filed on Sep. 30, 2025.
(60) Provisional application No. 63/703,312, filed on Oct. 4, 2024.

(51) Int. Cl. B64U 40/10; B64U 10/14; B64U 30/26; B64U 30/297; B64U 50/14; B64U 50/18; B64U 50/19; B64U 50/23

(52) U.S. Cl. CPC B64U 40/10; B64U 10/14; B64U 30/26; B64U 30/297; B64U 50/14; B64U 50/18; B64U 50/19; B64U 50/23; B64U 2201/10

(57) ABSTRACT

A quadrotor includes a body including a platform. A power source is positioned on the platform. A controller is positioned on the platform and operationally connected to the power source. A first rotor system is operatively connected to the controller and the power source. A second rotor system is operatively connected to the controller and the power source. A third rotor system is operatively connected to the controller and the power source, and a fourth rotor system is operatively connected to the controller and the power source. The controller is configured to articulate each of the first rotor system, the second rotor system, the third rotor system and the fourth rotor system about at least one axis independent of others of the first rotor system, the second rotor system, the third rotor system and the fourth rotor system.

### CROSS-REFERENCE TO RELATED APPLICATIONS

This application is a continuation-in-part of U.S. patent application Ser. No. 19/345,590 filed on Sep. 30, 2025. This application also claims the benefit and priority of U.S. Provisional Application No. 63/703,312 filed on Oct. 4, 2024. The entire disclosure of the above applications are incorporated herein by reference.

### FIELD

The present disclosure relates to the art of radio controlled and autonomous drones and, more particularly, to a quadrotor including multiple, independently articulable, rotor systems.

### BACKGROUND

Remotely controlled aerial vehicles or drones come in many sizes and configurations. Drones may include propellers that pull, propellers that push, propellers that lift or, in the case of a quad rotor, propellers that may act along more than one axis. A quadrotor includes a body that supports a power supply, a control system, a sensing system, a computation system, and a communication system. The body also supports four articulable rotor assemblies that each house a rotor system, including a propeller and servo motors to articulate the propeller. The four articulable rotor bodies/rotor systems are selectively controlled to produce stable flight. Quad rotors may move forward, rearward, or at angles. Quadrotors may also hover in place.

Quadrotor flight is controlled by sending signals to each of the rotor systems to change position from, for example, a horizontal orientation for hover to an angled orientation for directed flight, and then back to horizontal for hover. The direction of the directed flight would depend on the articulation angle induced to the propellers by the rotor articulation. However, regardless of the direction, the rotor bodies are controlled in pairs. A change in orientation of one rotor body is mirrored in the rotor body oppositely arranged. This coupled control is used to ensure control authority and/or stability in direct flight. In addition to coupled control, hover is only achieved when rotor systems are in a horizontal configuration with respect to the ground.

This section provides background information related to the present disclosure which is not necessarily prior art.

### SUMMARY

This section provides a general summary of the disclosure and is not a comprehensive disclosure of its full scope or all of its features.

A quadrotor, in accordance with the present disclosure, includes a body including a platform. The platform includes a forward end, an aft end, a first side, and a second side. A power source is positioned on the platform. A controller is positioned on the platform and operationally connected to the power source. A first rotor system positioned at the first side of the platform at the forward end and operatively connected to the controller and the power source. A second rotor system is positioned at the second side of the platform at the forward end and operatively connected to the controller and the power source. A third rotor system is positioned at the first side of the platform at the aft end and operatively connected to the controller and the power source, and a fourth rotor system is positioned at the second side of the platform at the aft end and operatively connected to the controller and the power source. The controller is configured to articulate each of the first rotor system, the second rotor system, the third rotor system and the fourth rotor system about at least one axis independent of others of the first rotor system, the second rotor system, the third rotor system and the fourth rotor system.

In other features, the first rotor system includes a first rotor housing having a first support shaft that is articulable relative to the platform about a first axis, and a first rotor member mounted to the first rotor housing through a first rotor shaft, the first rotor shaft being articulable relative to the first rotor housing about a second axis that is substantially perpendicular relative to the first axis.

In other features, the first rotor member includes a first propeller connected to the first rotor shaft through a first motor and a second propeller connected to the first rotor shaft through a second motor the first motor driving the first propeller in a first direction and the second motor driving the second propeller in a second direction that is opposite the first direction.

In other features, the second rotor system includes a second rotor housing having a second support shaft that is articulable relative to the platform about the first axis, and a second rotor member mounted to the second rotor housing through a second rotor shaft, the second rotor shaft being articulable relative to the second rotor housing about a third axis that is substantially perpendicular relative to the first axis.

In other features, the third rotor system includes a third rotor housing having a third support shaft that is articulable relative to the platform about a fourth axis that is substantially parallel to the first axis, and a third rotor member mounted to the third rotor housing through a third rotor shaft, the third rotor shaft being articulable relative to the third rotor housing about a fifth axis that is substantially perpendicular relative to the fourth axis.

In other features, the fourth rotor system includes a fourth rotor housing having a fourth support shaft that is articulable relative to the platform about the fourth axis, and a fourth rotor member mounted to the fourth rotor housing through a fourth rotor shaft, the fourth rotor shaft being articulable relative to the fourth rotor housing about a seventh axis that is substantially perpendicular relative to the fourth axis.

In other features, a first servo connects the first support shaft with the platform and a second servo connects the first rotor shaft with the first rotor housing.

In other features, a third servo connects the second support shaft with the platform and a fourth servo connects the second rotor shaft with the second rotor housing.

In other features, a fifth servo connects the third support shaft with the platform and a sixth servo connects the third rotor shaft with the third rotor housing.

In other features, a seventh servo connects the fourth support shaft with the platform and an eighth servo connects the fourth rotor shaft with the fourth rotor housing.

A drone, in accordance with the present disclosure, includes a body including a platform. The platform includes a forward end, an aft end, a first side, and a second side. A power source is positioned on the platform. A controller positioned on the platform and operationally connected to the power source. A plurality of rotors is connected to the platform the power source, and the controller. Each of the plurality of rotors is independently articulable about two axis independent of each of the other rotors of the plurality of rotors.

In other features, the plurality of rotors includes a first rotor system, a second rotor system, a third rotor system, and a fourth rotor system.

In other features, the first rotor system includes a first rotor housing and a first rotor member, the first rotor housing having a first support shaft connected to the platform through a first gimbal, the first support shaft being articulable relative to the platform about a first axis, the first rotor member being mounted to the first rotor housing through a first rotor shaft, the first rotor shaft being articulable relative to the first rotor housing about a second axis that is substantially perpendicular relative to the first axis.

In other features, the second rotor system includes a second rotor housing and a second rotor member, the second rotor housing having a second support shaft connected to the platform through a second gimbal, the second support shaft being articulable relative to the platform about the first axis, the second rotor member being mounted to the second rotor housing through a second rotor shaft, the second rotor shaft being articulable relative to the second rotor housing about a third axis that is substantially perpendicular relative to the first axis.

In other features, the third rotor system includes a third rotor housing and a third rotor member, the third rotor housing having a third support shaft mounted to the platform through a third gimbal, the third support shaft being articulable relative to the platform about a fourth axis that is substantially parallel to the first axis, the third rotor member being mounted to the third rotor housing through a third rotor shaft, the third rotor shaft being articulable relative to the third rotor housing about a fifth axis that is substantially perpendicular relative to the fourth axis.

In other features, the fourth rotor system includes a fourth rotor housing and a fourth rotor member, the fourth rotor housing having a fourth support shaft that mounted to the platform through a fourth gimbal, the fourth support shaft being articulable relative to the platform about the fourth axis, and the fourth rotor member being mounted to the fourth rotor housing through a fourth rotor shaft, the fourth rotor shaft being articulable relative to the fourth rotor housing about a seventh axis that is substantially perpendicular relative to the fourth axis.

In other features, a first servo connects the first support shaft with the platform and a second servo connects the first rotor shaft with the first rotor housing.

In other features, a third servo connects the second support shaft with the platform and a fourth servo connects the second rotor shaft with the second rotor housing.

In other features, a fifth servo connects the third support shaft with the platform and a sixth servo connects the third rotor shaft with the third rotor housing.

In other features, a seventh servo connects the fourth support shaft with the platform and an eighth servo connects the fourth rotor shaft with the fourth rotor housing.

In another aspect of this disclosure, the quadrotor is equipped to avoid inter-rotor downwash interference and mechanical gimbal lock. In particular, the controller is configured to detect a given rotor system in at least one of a first rotor pair or a second rotor pair that is articulated such that its thrust vector points directly along a thrust axis toward an opposing rotor system and, in response to detecting the given rotor pair, tilts the given rotor system away from the thrust axis. For example, the controller tilts the given rotor system at an angle between zero and forty-five degrees from the thrust axis. It is noted that the redistributes thrust among the first rotor system, the second rotor system, the third rotor system and the fourth rotor system without changing a thrust vector of the quadrotor.

In yet another aspect, the controller is configured to detect occurrence of a total force vector for the quadrotor being parallel with the longitudinal axis of the platform or the transverse axis of the platform and tilt at least one rotor system in each of the first rotor pair and the second rotor pair to advert co-linear thrust vectors in the first rotor pair and the second rotor pair. More specifically, the controller is configured to tilt each of the first rotor system, the second rotor system, the third rotor system and the fourth rotor system such that an individual thrust vector for each of the first rotor system, the second rotor system, the third rotor system and the fourth rotor system is not parallel with the longitudinal axis.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations and are not intended to limit the scope of the present disclosure.

FIG. 1 is an upper left perspective view of a quadrotor including multiple, independently articulable rotor systems, in accordance with the present disclosure;

FIG. 2 is a perspective view of a first one of the multiple, independently articulable rotor systems, in accordance with the present disclosure;

FIG. 3 is a perspective view of a second one of the multiple, independently articulable rotor systems, in accordance with the present disclosure;

FIG. 4 is a perspective view of a third one of the multiple, independently articulable rotor systems, in accordance with the present disclosure;

FIG. 5 is a perspective view of a fourth one of the multiple, independently articulable rotor systems, in accordance with the present disclosure;

FIG. 6 is a perspective view of the quadrotor of FIG. 1, in a first flight orientation, in accordance with the present disclosure;

FIG. 7 is a perspective view of the quadrotor of FIG. 6 in a second flight orientation, in accordance with the present disclosure;

FIG. 8 is a perspective view of the quadrotor of FIG. 7 in a third flight orientation, in accordance with the present disclosure;

FIG. 9 is a perspective view of the quadrotor of FIG. 8 in a fourth flight orientation, in accordance with the present disclosure;

FIG. 10 is a perspective view of the quadrotor of FIG. 9 in a fifth flight orientation, in accordance with the present disclosure;

FIG. 11 is a perspective view of the quadrotor of FIG. 10 in a sixth flight orientation, in accordance with the present disclosure;

FIG. 12 is a schematic view of a flight controller for the quadrotor, in accordance with the present disclosure; and

FIG. 13 is a schematic diagram depicting coordinate frames and servo angles used by the flight controller in accordance with the present disclosure.

Corresponding reference numerals indicate corresponding parts throughout the several views of the drawings.

### DETAILED DESCRIPTION

Example embodiments will now be described more fully with reference to the accompanying drawings.

As drones grow in popularity, their use as tools also grows. Drones serve as photography platforms, sensor platforms, delivery platforms and the like. Currently, operating a drone to control and use a tool is difficult. The drone is only capable of hovering when its body and all rotors are horizontal with respect to the ground. As such precise positioning and manipulation of the tool is nearly impossible.

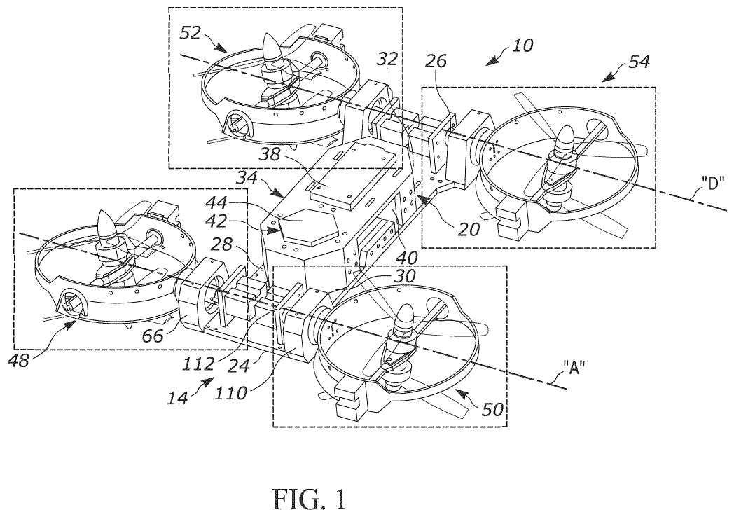

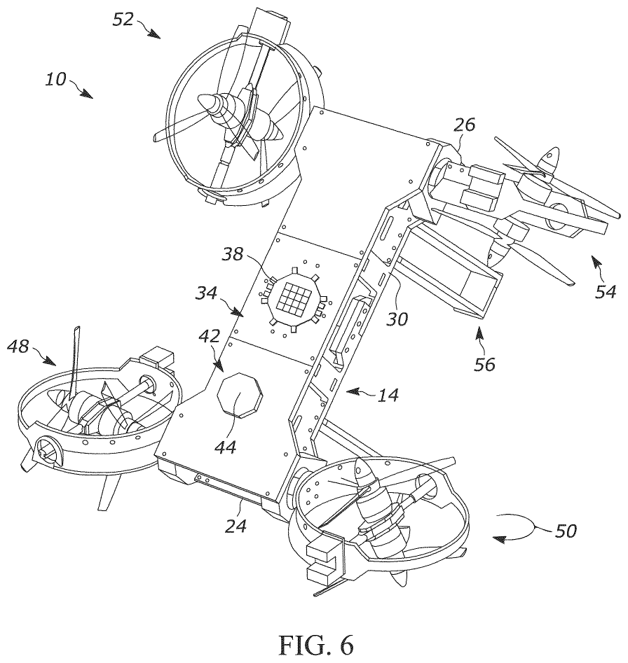

A drone, shown in the form of a quadrotor in FIG. 1 is indicated generally at 10. Quadrotor 10 includes a body 14 defined by a platform 20 having a forward end 24, an aft end 26 (FIG. 6), a first side 28, and a second side 30. First side 28 and second side 30 extend between and connect with forward end 24 and aft end 26. Platform 20 also includes an upper surface 32 that supports a housing 34. Body 14 may include a plurality of support members such as shown at 36 in FIG. 6. A flight controller 38 is provided in housing 34. In addition to supporting flight controller 38, housing 34 also supports a battery or power source 40, a receiver 42 including an antenna 44. At this point, it should be recognized that while shown as a quad rotor, the drone may have any number of rotors greater than unity.

In accordance with the present disclosure, quadrotor 10 includes a first rotor system 48, a second rotor system 50, a third rotor system 52, and a fourth rotor system 54. As will be detailed more fully herein each rotor system is articulable about two distinct axes. In addition, rotor systems 48, 50, 52, and 54 are decoupled from one another. More specifically, movement, i.e., articulation of any one of the first rotor system 48, second rotor system 50, third rotor system 52, and fourth rotor system 54 is independent of all the other rotor systems.

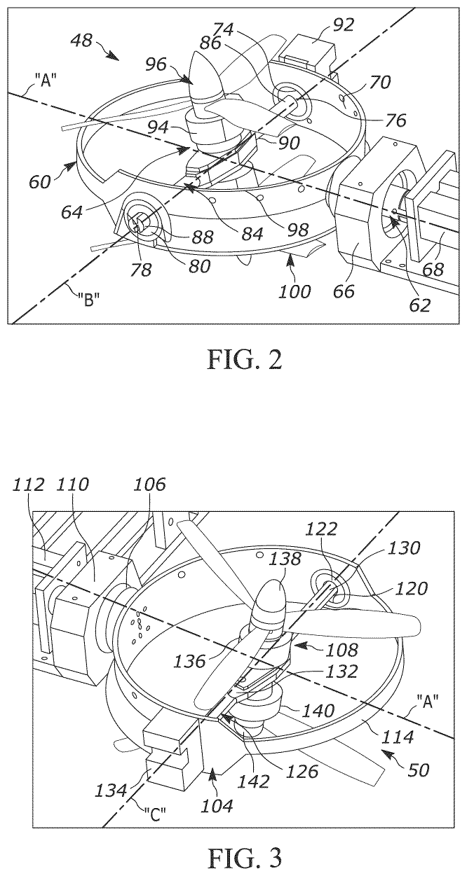

As shown in FIG. 2, first rotor system 48 includes a first rotor housing 60 connected to a first support shaft 62 and surrounds a first rotor member 64. First support shaft 62 is supported in a first gimbal 66 provided on upper surface 32 of platform 20 at forward end 24. First gimbal 66 is aligned with first side 28 and supports rotary movement of first support shaft 62 about a first axis of rotation “A” provided by a first servo 68. First servo 68 is operatively connected to flight controller 38 as well as battery 40.

First rotor housing 60 includes a first support wall 70 having a first passage 74 supporting a first bearing 76 and a second passage 78 supporting a second bearing 80. Second passage 78 is spaced 180° from first passage 74. A first rotor shaft 84 supports first rotor member 64 and extends between first bearing 76 and second bearing 80. First rotor shaft 84 includes a first end 86, a second end 88, and an intermediate portion 90 that extends between first end 86 and a second end 88. First end 86 projects outward from first bearing 76 and is connected to a second servo 92. Second servo 92 rotates first rotor shaft 84 about a second axis “B” that is substantially perpendicular to first axis “A”. Second servo 92 is operatively connected to flight controller 38 as well as battery 40.

First rotor member 64 includes a first motor 94 connected to a first propeller 96 and a second motor 98 connected to a second propeller 100. First motor 94 and second motor 96 are operatively connected to flight controller 38 as well as battery 40. First motor 94 rotates, first propeller 96 about a first propeller axis and second motor 96 rotates second propeller 100 about the first propeller axis. While the axis of rotation may be shared, the direction of rotation of first propeller 96 and second propeller 100 are opposites. In this manner, when in operation, drag forces generated by first propeller 96 are cancelled out by drag forces created by second propeller 100. Similarly, when in operation, the angular momentum produced by first propeller 96 is cancelled out by the angular momentum produced by second propeller 100.

Referring to FIG. 3, second rotor system 50 includes a second rotor housing 104 connected to a second support shaft 106 and surrounds a second rotor member 108. Second support shaft 106 is supported in a second gimbal 110 provided on upper surface 32 of platform 20 at forward end 24. Second gimbal 110 is aligned with second side 30 and supports rotary movement of second support shaft 106 about the first axis of rotation “A” provided by a third servo 112. Third servo 112 is operatively connected to flight controller 38 as well as battery 40.

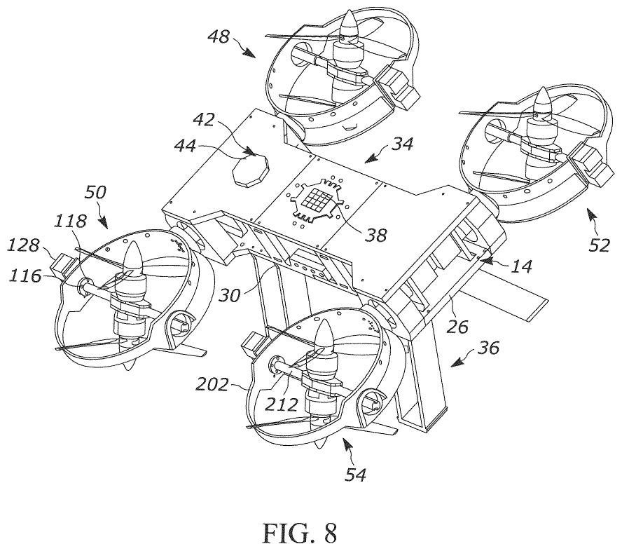

Second rotor housing 104 includes a second support wall 114 having a first passage 116 supporting a first bearing 118 (FIG. 8) and a second passage 120 supporting a second bearing 122. Second passage 120 is spaced 180° from first passage 116. A second rotor shaft 126 supports second rotor member 108 and extends between first bearing 118 and second bearing 122. Second rotor shaft 126 includes a first end 128, a second end 130, and an intermediate portion 132 that extends between first end 128 and a second end 130. First end 128 projects outward from first bearing 118 and is connected to a fourth servo 134. Fourth servo 134 rotates second rotor shaft 126 about a fourth axis “C” that is substantially perpendicular to first axis “A”. Fourth servo 134 is operatively connected to flight controller 38 as well as battery 40.

Second rotor member 108 includes a third motor 136 connected to a third propeller 138 and a fourth motor 140 connected to a fourth propeller 142. Third motor 136 and fourth motor 140 are operatively connected to flight controller 38 as well as battery 40. Third motor 136 rotates third propeller 138 about a second propeller axis and fourth motor 140 rotates fourth propeller 142 about the second propeller axis. While the axis of rotation may be shared, the direction of rotation of third propeller 138 and fourth propeller 142 are opposites. In this manner, when in operation, drag forces generated by third propeller 138 are cancelled out by drag forces created by fourth propeller 142. Similarly, when in operation, the angular momentum produced by third propeller 138 is cancelled out by the angular momentum produced by fourth propeller 142.

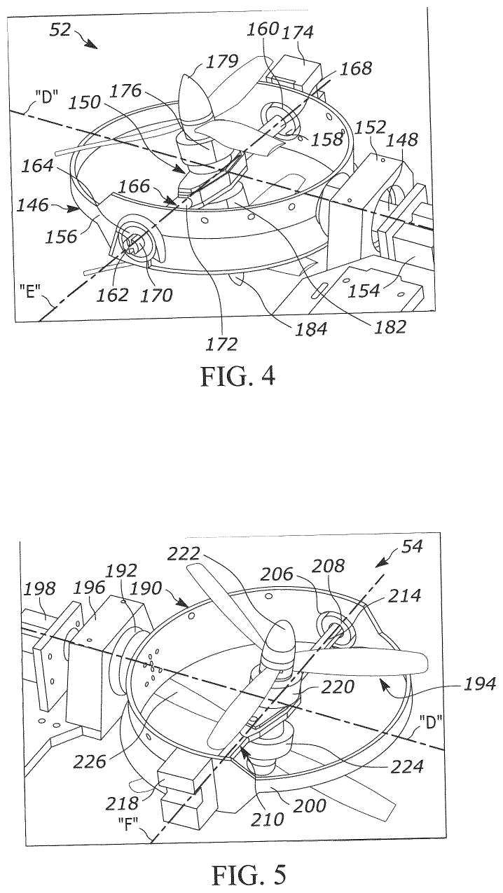

Turning to FIG. 4, third rotor system 52 includes a third rotor housing 146 connected to a third support shaft 148 and surrounds a third rotor member 150. Third support shaft 148 is supported in a third gimbal 152 provided on upper surface 32 of platform 20 at aft end 26. Third gimbal 152 is aligned with first side 28 and supports rotary movement of third support shaft 148 about a fifth axis of rotation “D” provided by a fifth servo 154. Fifth axis of rotation “D” is substantially parallel to first axis of rotation “A”. Fifth servo 154 is operatively connected to flight controller 38 as well as battery 40.

Third rotor housing 146 includes a third support wall 156 having a first passage 158 supporting a first bearing 160 and a second passage 162 supporting a second bearing 164. Second passage 162 is spaced 180° from first passage 158. A third rotor shaft 166 supports third rotor member 150 and extends between first bearing 160 and second bearing 164. Third rotor shaft 166 includes a first end 168, a second end 170, and an intermediate portion 172 that extends between first end 168 and a second end 170. First end 168 projects outward from first bearing 160 and is connected to a sixth servo 174. Sixth servo 174 rotates third rotor shaft 166 about a sixth axis “E” that is substantially perpendicular to fifth axis of rotation “D”. Sixth servo 174 is operatively connected to flight controller 38 as well as battery 40.

Third rotor member 150 includes a fifth motor 176 connected to a fifth propeller 179 and a sixth motor 182 connected to a sixth propeller 184. Fifth motor 176 and sixth motor 182 are connected to intermediate portion 172 of third rotor shaft 166. Fifth motor 176 and sixth motor 182 are operatively connected to flight controller 38 as well as battery 40. Fifth motor 176 rotates fifth propeller 179 about a third propeller axis and sixth motor 182 rotates sixth propeller 184 about the third propeller axis. While the axis of rotation may be shared, the direction of rotation of fifth propeller 179 and sixth propeller 184 are opposites. In this manner, when in operation, drag forces generated by fifth propeller 179 are cancelled out by drag forces created by sixth propeller 184. Similarly, the angular momentum produced by fifth propeller 179 is cancelled out by the angular momentum produced by sixth propeller 184.

Referring to FIG. 5, fourth rotor system 54 includes a fourth rotor housing 190 connected to a fourth support shaft 192 and surrounds a fourth rotor member 194. Fourth support shaft 192 is supported in a fourth gimbal 196 provided on upper surface 32 of platform 20 at aft end 26. Fourth gimbal 196 is aligned with second side 30 and supports rotary movement of fourth support shaft 192 about the fifth axis of rotation “D” provided by a seventh servo 198. Seventh servo 198 is operatively connected to flight controller 38 as well as battery 40. Similarly, when in operation, the angular momentum produced by fifth propeller 179 is cancelled out by the angular momentum produced by sixth propeller 184.

Fourth rotor housing 190 includes a fourth support wall 200 having a first passage 202 supporting a first bearing 204 (FIG. 8) and a second passage 206 supporting a second bearing 208. Second passage 206 is spaced 180° from first passage 202. A fourth rotor shaft 210 supports fourth rotor member 194 and extends between first bearing 204 and second bearing 208. Fourth rotor shaft 210 includes a first end 212, a second end 214, and an intermediate portion 216 that extends between first end 212 and a second end 214. First end 212 projects outward from first bearing 204 and is connected to an eighth servo 218. Eighth servo 218 rotates fourth rotor shaft 210 about the sixth axis “F” that is substantially perpendicular to fifth axis of rotation “D”. Eighth servo 218 is operatively connected to flight controller 38 as well as battery 40.

Fourth rotor member 194 includes a seventh motor 220 connected to a seventh propeller 222 and an eighth motor 224 connected to an eighth propeller 226. Seventh motor 220 and eighth motor 224 are connected to intermediate portion 216 of fourth rotor shaft 210. Seventh motor 220 and eighth motor 224 are operatively connected to flight controller 38 as well as battery 40. Seventh motor 220 rotates seventh propeller 222 about a fourth propeller axis and eighth motor 224 rotates eighth propeller 226 about the fourth propeller axis. While the axis of rotation may be shared, the direction of rotation of seventh propeller 222 and eighth propeller 226 are opposites. In this manner, when in operation, drag forces generated by seventh propeller 222 are cancelled out by drag forces created by eighth propeller 226. Similarly, when in operation, the angular momentum produced by seventh propeller 222 is cancelled out by the angular momentum produced by eighth propeller 226.

As will be detailed more fully herein, first rotor system 48, second rotor system 50, third rotor system 52, and fourth rotor system 54 are independently orientable to establish a desired flight attitude of quadrotor 10. As shown in FIG. 6, each of the first rotor system 48, second rotor system 50, third rotor system 52, and fourth rotor system 54 may be oriented at a different rotation position about the first axis “A” and the fourth axis “D”. More specifically, first rotor system 48 is decoupled from second rotor system 50, third rotor system 52, and fourth rotor system 54; second rotor system 50 is decoupled from first rotor system 48, third rotor system 52, and fourth rotor system 54; third rotor system 52 is decoupled from first rotor system 48, second rotor system 50, and fourth rotor system 54; and fourth rotor system 54 is decoupled from first rotor system 48, second rotor system 50, and third rotor system 52.

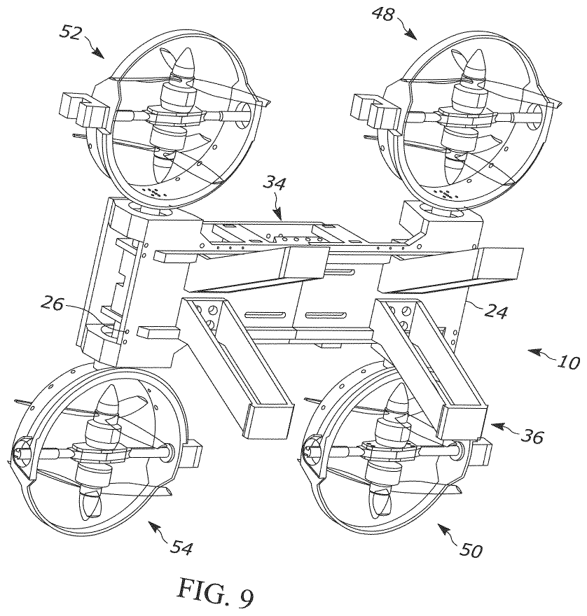

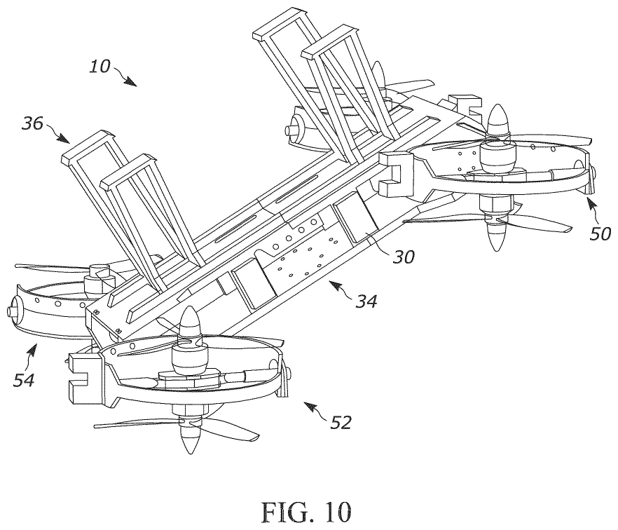

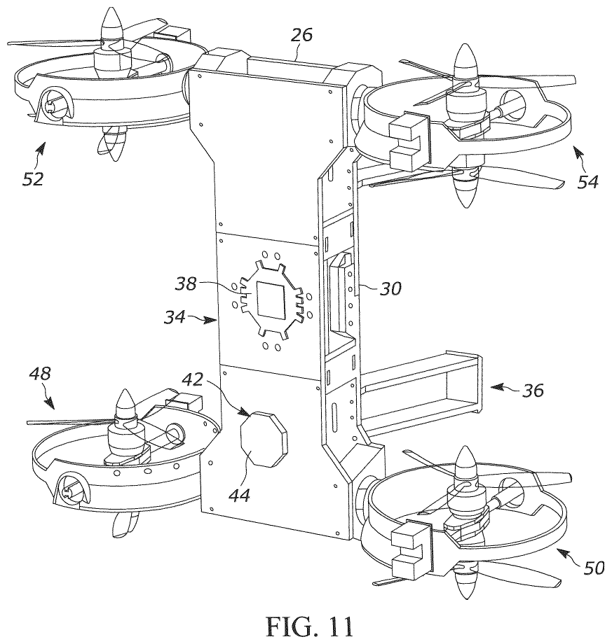

With this arrangement, quadrotor 10 may take on one of any number of flight attitudes such as shown in FIGS. 6, 7, 8, 9, 10, and 11. Body 14 may be angled relative to a horizontal axis such as shown in FIGS. 6, 7, and 11, may be rotated relative to the horizonal axis such as shown in FIGS. 8 and 9, or body 14 may have a multi-axis orientation such as shown in FIG. 10. The flexibility provided by decoupling each of the first rotor system 48, second rotor system 50, third rotor system 52, and fourth rotor system 54 from any other of the first rotor system 48, second rotor system 50, third rotor system 52, and fourth rotor system 54 allows for a unique flight envelope that may be employed in various endeavors such as tracking, surveillance, tool manipulation, and the like.

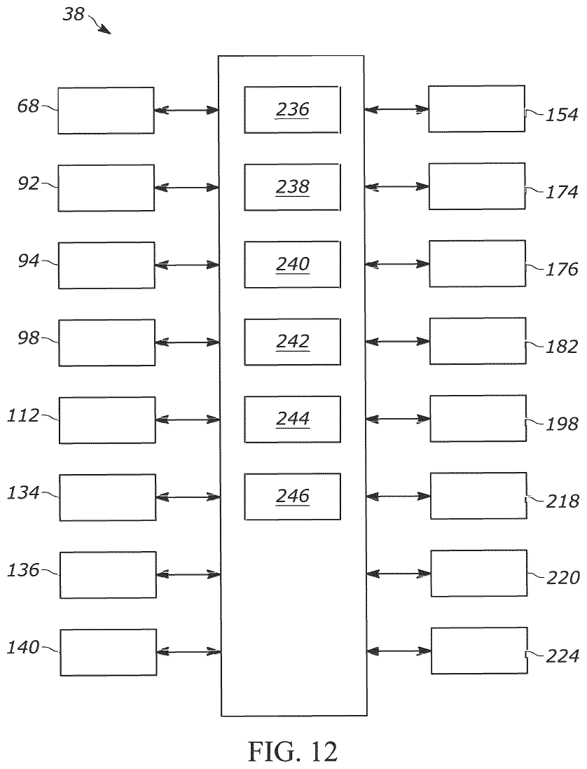

Referring to FIG. 12, flight controller 38 includes a central processing unit (CPU) 236, a rotor housing control module 238, a rotor member control module 240, a feedback control module 242, a rotor control module 244, and a non-transient memory 246. Flight controller 38 receives signals from receiver 42 commanding a direction of flight. Rotor housing control module 238 directs one or more of the first rotor housing 60, second rotor housing 104, third rotor housing 146 and/or fourth rotor housing 190 to rotate about their respective axes to a selected position. Concurrently, rotor member control module 240 commands one or more of first rotor member 64, second rotor member 108, third rotor member 150 and or fourth rotor member 194 to rotate about their respective axes to a selected position. The selected position corresponds to the directed flight direction.

As the rotor housings and rotor members articulate, each of the servos provides position feedback to feedback control module 242. Position feedback may be provided through rotary encoders (not shown) associated with corresponding ones of first servo 68. Second servo 92, third servo 112. Fourth servo 134, fifth servo 154, sixth servo 174, seventh servo 198, and eighth servo 218.

The position feedback is processed and used by rotor housing control module 238 and rotor member control module 240 to adjust each of the first rotor housing 60, second rotor housing 104, third rotor housing 146 and/or fourth rotor housing 190 and each of the first rotor member 64, second rotor member 108, third rotor member 150 and or fourth rotor member 194 to achieve stable flight at a commanded orientation of platform 22. By utilizing independently controllable rotor systems, flight controller 38 may achieve hover with platform 20 being in any commanded position and orientation without the need for each of the first rotor housing 60, second rotor housing 104, third rotor housing 146 and/or fourth rotor housing 190 to be in a horizontal orientation with respect to body 14 of quadrotor 10.

In accordance with the present disclosure, flight controller allocates commands to each rotor system 48, 50, 52, and 54 to establish a selected flight orientation and translation for quadrotor 10. Command or control allocation refers to how high-level control commands translate to low-level motor commands. In accordance with the present disclosure, flight controller 38 can control the direction and magnitude of the thrust (basically the individual thrust vectors ^{→}ti|B in body-fixed frame B) for each rotor system 48, 50, 52, and 54. For example, each rotor system 48, 50, 52, and 54 can be controlled to generate an independent thrust vector. The low-level commands αi, βi and Ωi for one rotor system are decoupled with the values for the other rotor systems. In this manner, the value of individual thrust vectors ^{→}ti|B, can be used to determine find the command values αi, βi and Ωi. Note that, in a non-limiting example, the magnitude of ∥^{→}ti|B∥ determines the angular velocity of the propeller Ωi and direction t\hat{ }i|B determines the values of servo motor angles αi and βi.

In another aspect of this disclosure, the quadrotor 10 is equipped to avoid inter-rotor downwash interference and mechanical gimbal lock. In particular, the controller is configured to detect a given rotor system in at least one of a first rotor pair or a second rotor pair that is articulated such that its thrust vector points directly along a thrust axis toward an opposing rotor system and, in response to detecting the given rotor pair, tilts the given rotor system away from the thrust axis. For example, the controller tilts the given rotor system at an angle between zero and forty-five degrees from the thrust axis. It is noted that the redistributes thrust among the first rotor system, the second rotor system, the third rotor system and the fourth rotor system without changing a thrust vector of the quadrotor. This feature is described in more detail below.

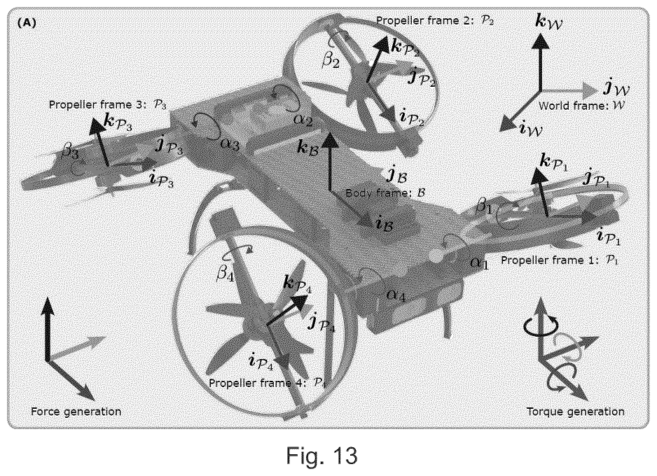

The omnidirectional maximum thrust vectoring capability of quadrotor 10 originates from the gimbal-mounted coaxial rotor systems, whose servo-driven tilt angles appear directly in the equations of motion. Define four coordinate frames for the derivation: the world frame W, the body-fixed frame [symbol] , and a propeller-fixed frame [symbol] for each rotor arm i∈{1, 2, 3, 4}. The frame conventions and servo angles are shown in FIG. 13. By design, the [symbol] - to − [symbol] ᵢ transformation is parameterized by two servo positions: αᵢ controlled by the inner servo and βᵢ by the outer servo. These servo angles provide additional actuator commands alongside the propeller speeds, giving quadrotor a total of twelve independent control inputs.

The translational dynamics are

\dot{p}=v,mv=mg+Rf, (1)

where p∈ [symbol] ³ and v∈ [symbol] ³ are position and velocity in W, m is the quadrotor mass, g∈ [symbol] ³ is the gravitational acceleration in W, R∈SO(3) is the rotation matrix from [symbol] to W, and f∈ [symbol] ³ is the total propeller force in [symbol] .

The gimbal design enables the generation of rotor thrust, and thus the body forces f in any direction. Each rotor system produces a vectorized thrust whose direction is set by the servo angles αᵢ, βᵢ and whose magnitude scales with the propeller angular velocity Ωᵢ. The body-frame force is

$$f = {\sum }_{i = 1}^{4} {t}_{i} = {c}_{t} {\sum }_{i = 1}^{4} {G}_{i} ( {α}_{i} , {β}_{i} ) {Ω}_{i}^{2} , \qquad ( 2 )$$

where cₜ is the thrust coefficient and the thrust direction vector

$${G}_{i} ( {α}_{i} , {β}_{i} ) = [ \begin{matrix}sin {α}_{i} cos {β}_{i} \\ - sin {β}_{i} \\ cos {α}_{i} cos {β}_{i}\end{matrix} ] \qquad ( 3 )$$

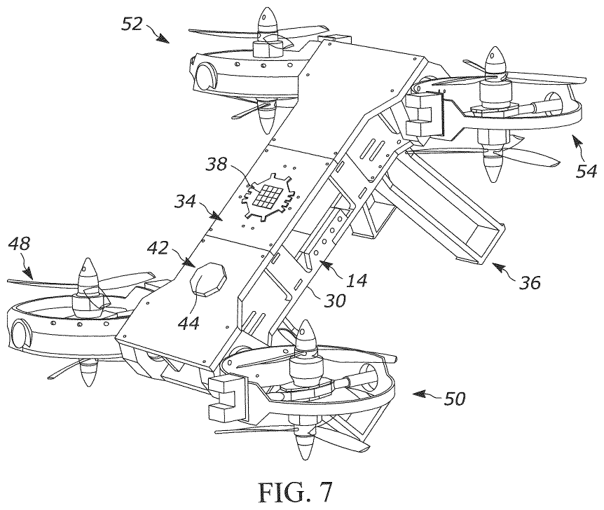

results from two intrinsic rotations of the gimbal: first by αᵢ about the j_{B} axis (inner servo), then by βᵢ about the rotated is axis (outer servo), as shown in FIG. 7.

The rotational dynamics follow Euler's equations,

\dot{R}=R[ω]ₓ,J\dot{ω}=−ω×Jω+τ, (4)

where w∈ [symbol] ³ is the angular velocity in [symbol] , [⋅]ₓ: [symbol] ³→ [symbol] ^{3×3} is the skew-symmetric matrix operator, J∈ [symbol] ^{3×3} is the inertia matrix in [symbol] , and τ∈ [symbol] ³ is the propeller torque in [symbol] .

A key advantage of the coaxial design is that each pair of counter-rotating propellers cancels the aerodynamic drag torque and eliminates the gyroscopic reaction that would otherwise resist gimbal motion. The servos can therefore redirect thrust using minimal effort, and the net torque on the body reduces to the moment of each thrust vector about the center of mass (COM),

$$τ = {\sum }_{i = 1}^{4} {l}_{i} \times {t}_{i} , \qquad ( 5 )$$

where lᵢ=[l_{i,x}, l_{i,y}, l_{i,z}]^{T} is the position vector from the COM to the center of propeller i, and

$${t}_{i} = {c}_{t} {G}_{i} ( {α}_{i} , {β}_{i} ) {Ω}_{i}^{2}$$

is the thrust of propeller i in [symbol] . Substituting yields

$$τ = {c}_{t} {\sum }_{i = 1}^{4} {H}_{i} ( {α}_{i} , {β}_{i} ) {Ω}_{i}^{2} , \qquad ( 6 )$$

$$where$$

$${H}_{i} ( {α}_{i} , {β}_{i} ) = [ \begin{matrix}{l}_{i , y} cos {α}_{i} cos {β}_{i} + {l}_{i , z} sin {β}_{i} \\ - {l}_{i , x} cos {α}_{i} cos {β}_{i} + {l}_{i , z} sin {α}_{i} cos {β}_{i} \\ - {l}_{i , x} sin {β}_{i} - {l}_{i , y} sin {α}_{i} cos {β}_{i}\end{matrix} ] . \qquad ( 7 )$$

Combining the force (2) and torque (6) expressions gives the full wrench,

$$w = {c}_{t} {\sum }_{i = 1}^{4} [ \begin{matrix}{G}_{i} ( {α}_{i} , {β}_{i} ) \\ {H}_{i} ( {α}_{i} , {β}_{i} )\end{matrix} ] {Ω}_{i}^{2} = {c}_{t} F {Ω°}^{2} , \qquad ( 8 )$$

where w=[f^{T} τ^{T}]^{T}∈ [symbol] ⁶ is the stacked force-torque vector, F(α, β)∈ [symbol] ^{6×4} stacks the perrotor wrench-direction vectors

$${[ \begin{matrix}{G}_{i}^{T} & {H}_{i}^{T}\end{matrix} ]}^{T}$$

as columns, Ω=[Ω₁ Ω₂ Ω₃ Ω₄]^{T}, and (⋅)°² denotes the element-wise square.

For control design, it is convenient to treat the individual thrust vectors tᵢ∈ [symbol] ³ as abstracted inputs rather than the rotor speeds Ωi. Stacking all four thrust vectors into

$$t = {[ \begin{matrix}{t}_{1}^{T} & {t}_{2}^{T} & {t}_{3}^{T} & {t}_{4}^{T}\end{matrix} ]}^{T} \vert ∈ {ℝ}^{12} ,$$

the wrench can be written in compact form as

w=Mt, (9)

where M∈ [symbol] ^{6×12} is a constant matrix determined by the fixed rotor positions li in B. Since the matrix is wide and always full row-rank, the input has control over all wrench channels: the actuators can always produce a compensating input in the same subspace as an external force and torque disturbance, i.e., every disturbance is matched. In addition, M also serves as the basis for the thrust allocation described below.

The central capability of quadrotor 10 is the independent generation of forces and torques in all six degrees of freedom, enabling omnidirectional trajectory tracking in SE. In an example embodiment, the quadrotor employs a three-layer control architecture: a geometric controller that tracks desired trajectories on SE, an [symbol] ₁ adaptive augmentation that compensates for unknown disturbances, and a thrust allocation strategy that converts desired wrenches into rotor commands while maximizing hovering efficiency and avoiding actuation deficiencies.

The geometric controller computes desired body-frame force and torque from tracking errors defined directly on the SE manifold, avoiding the singularities inherent in Euler angle representations. The tracking errors consist of two configuration-level errors and two rate-level errors,

$${e}_{p} = p - {p}_{d} , ( position error ) \qquad ( 10 )$$

$${e}_{R} = \frac{1}{2} {( {R}_{d}^{T} R - {R}^{T} {R}_{d} )}^{∨} , ( orientation error )$$

$${e}_{v} = v - {v}_{d} , ( linear velocity error )$$

$${e}_{ω} = ω - {R}^{T} {R}_{d} {ω}_{d} , ( angular velocity error )$$

where p_{d}, v_{d}, R_{d}, ω_{d} are the desired position, velocity, rotation matrix, and angular velocity, and (⋅)^{v}: [symbol] (3)→ [symbol] ³ is the map that extracts a 3D vector from a skew-symmetric matrix. The desired force and torque are

f_{Geo}=R^{T}(−kₚeₚ−kᵥeᵥ−mg+m\ddot{p}_{d}),

τ_{Geo}=−k_{R}e_{R}−k_{ω}e_{ω}+ωχJω−J(ω×R^{T}R_{d}ω_{d}−R^{T}R_{d}\dot{ω}_{d}). (11)

Operating directly on the nonlinear SO manifold avoids the singularities present in minimal rotation parameterizations. This formulation provides almost-global asymptotic stability, meaning convergence to any desired pose from all initial conditions except a zero-measure.

The geometric controller guarantees exponential stability for the nominal dynamics in (1) and (4). In practice, quadrotor encounters unknown disturbances such as wind and ground effects. To maintain robust tracking, we augment the geometric controller with an [symbol] ₁ adaptive law that estimates and cancels these disturbances in real time. The augmented dynamics are

\dot{p}=v,m\dot{v}=mg+R(f_{Geo}+f_{aug})+f_{d},

\dot{R}=R[ω]ₓ,Jω=−ω×Jω+τ_{Geo}+τ_{aug}+τ_{d},

where f_{aug} and τ_{aug} are the adaptive compensation terms in the body frame [symbol] , and f_{d}, τ_{d} are the unknown disturbance force and torque. The adaptive force f_{aug} is expressed in [symbol] alongside the nominal force f_{Geo} and rotated to the world frame by R, while the disturbance f_{d} acts in W. Defining the stacked velocity state z=[v^{T} ω^{T}]^{T}, the dynamics can be written as

\dot{p}=v,m\dot{v}=mg+R(f_{Geo}+f_{aug})+f_{d},

\dot{R}=R[ω]ₓ,J\dot{ω}−ω×Jω+τ_{Geo}+τ_{aug}+τ_{d},

where f_{aug} and τ_{aug} are the adaptive compensation terms in the body frame [symbol] , and f_{d}, τ_{d} are the unknown disturbance force and torque. The adaptive force f_{aug} is expressed in [symbol] alongside the nominal force f_{Geo} and rotated to the world frame by R, while the disturbance f_{d} acts in W.

Defining the stacked velocity state z=[v^{T} ω^{T}]^{T}, the dynamics can be written as

$$\dot{z} = f ( z ) + G ( R ) ( {u}_{Geo} - {u}_{aug} ) + {Bu}_{d} , \qquad ( 12 )$$

$$where$$

$$f ( z ) = [ \begin{matrix}g \\ - {J}^{- 1} ω \times J ω\end{matrix} ] , G ( R ) = [ \begin{matrix}{m}^{- 1} R & {0}_{3 \times 3} \\ {0}_{3 \times 3} & {J}^{- 1}\end{matrix} ] , B = [ \begin{matrix}{m}^{- 1} {I}_{3} & {0}_{3 \times 3} \\ {0}_{3 \times 3} & {J}^{- 1}\end{matrix} ] ,$$

$${u}_{Geo} = {[ \begin{matrix}{f}_{Geo}^{T} & {τ}_{Geo}^{T}\end{matrix} ]}^{T} , {u}_{aug} = {[ \begin{matrix}{f}_{aug}^{T} & {τ}_{aug}^{T}\end{matrix} ]}^{T} , {u}_{d} = {[ \begin{matrix}{f}_{d}^{T} & {τ}_{d}^{T}\end{matrix} ]}^{T} .$$

The matrix G(R) maps body-frame control inputs to W-frame accelerations via R, while B maps the W-frame disturbance force and the B-frame disturbance torque.

The [symbol] ₁ adaptive controller consists of a state predictor, a piecewise-constant adaptation law, and a low-pass filter (LPF). At each control step, the algorithm uses the prediction error to estimate the disturbance and produces a filtered compensation signal.

The state predictor mirrors the plant dynamics with an additional error-injection term,

ż=f(z)+G(R)(u_{Geo}+u_{aug})+h(t)+Aₛ\tilde{z}, (13)

where \tilde{z}=\hat{z}−z is the prediction error, Aₛ∈ [symbol] ^{6×6} is a user-selected diagonal Hurwitz matrix that governs the predictor convergence rate, and h(t)∈ [symbol] ⁶ is the acceleration-space estimate of the total disturbance contribution Bu_{d}. The piecewise-constant adaptation law computes h and the corresponding disturbance estimate û_{d} at each discrete time step k as

hₖ=−(exp(AₛTₛ)−I)⁻¹Aₛ exp(AₛTₛ)\tilde{z}ₖ,ũ_{d,k}=−B⁻¹hₖ, (14)

where Tₛ is the sampling time. The force component of û_{d,k} is rotated from W into B via R^{T} before filtering. The estimate is then passed through first-order LPFs with separate bandwidths ω_{f,v} for force and ω_{f,ω} for torque (both in rad/s), and the adaptive compensation u_{aug,k} is obtained by negating the filtered output.

As an overactuated omnidirectional platform, quadrotor 10 must convert the six-dimensional desired wrench w=[f^{T} τ^{T}]^{T} into twelve low-level commands: four gimbal angle pairs (αᵢ, βᵢ) and four rotor speeds Ωᵢ. The allocation exploits the fact that each rotor's thrust direction and magnitude are independently controllable. Because the low-level commands αᵢ, βᵢ, and Ωᵢ of each rotor are decoupled, it suffices to find the four three-dimensional thrust vectors tᵢ, from which the individual commands can be recovered.

One can decompose each rotor's thrust vector, tᵢ, into four additive terms: one quarter of the total desired force, plus three torque contributions for roll, pitch, and yaw. For a symmetric construction with half-length l=|l_{i,x}|, half-width b=|l_{i,y}|, and diagonal distance r=\sqrt{l²+b²} from the COM to each propeller, the perrotor thrust vectors are

$${t}_{1} = \frac{f}{4} + \frac{{τ}_{x}}{4 b} {k}_{ℬ} - \frac{{τ}_{y}}{4 l} {k}_{ℬ} + \frac{{τ}_{z}}{4 r} {\hat{e}}_{{ψ}_{1}} , \qquad ( 15 )$$

$${t}_{2} = \frac{f}{4} - \frac{{τ}_{x}}{4 b} {k}_{ℬ} - \frac{{τ}_{y}}{4 l} {k}_{ℬ} + \frac{{τ}_{z}}{4 r} {\hat{e}}_{{ψ}_{2}} ,$$

$${t}_{3} = \frac{f}{4} - \frac{{τ}_{x}}{4 b} {k}_{ℬ} + \frac{{τ}_{y}}{4 l} {k}_{ℬ} + \frac{{τ}_{z}}{4 r} {\hat{e}}_{{ψ}_{3}} ,$$

$${t}_{4} = \frac{f}{4} + \frac{{τ}_{x}}{4 b} {k}_{ℬ} + \frac{{τ}_{y}}{4 l} {k}_{ℬ} + \frac{{τ}_{z}}{4 r} {\hat{e}}_{{ψ}_{4}} ,$$

where τ=[τₓ τ_{y} τ_{z}]^{T} are the scalar components of the desired torque. The unit vectors ê_{ψ}_{ᵢ} (denoting the yaw-torque direction for rotor i) lie in the [symbol] - [symbol] plane, perpendicular to the corresponding rotor arms,

$${\hat{e}}_{{ψ}_{1}} = [ \begin{matrix}- b / r \\ l / r \\ 0\end{matrix} ] , {\hat{e}}_{{ψ}_{2}} = [ \begin{matrix}b / r \\ l / r \\ 0\end{matrix} ] , {\hat{e}}_{{ψ}_{3}} = [ \begin{matrix}b / r \\ - l / r \\ 0\end{matrix} ] , {\hat{e}}_{{ψ}_{4}} = [ \begin{matrix}- b / r \\ - l / r \\ 0\end{matrix} ] . \qquad ( 16 )$$

The decomposition in (15) is equivalent to the Moore-Penrose pseudo-inverse solution t=M^{†}w with M^{†}=M^{T}(MM^{T})⁻¹, which yields optimal thrust efficiency analogous to the minimumnorm allocation of a conventional quadrotor.

Since

$${t}_{i} = {c}_{t} {G}_{i} ( {α}_{i} , {β}_{i} ) {Ω}_{i}^{2} ,$$

the rotor speed and servo angles can be recovered from each thrust vector. Defining the unit thrust direction \hat{t}ᵢ=tᵢ/∥tᵢ∥ with components \hat{t}₁=[\hat{t}_{i,x} \hat{t}_{i,y} \hat{t}_{i,z}]^{T}, the trigonometric relations give Ωᵢ=\sqrt{∥tᵢ∥/cₜ}, and

$$\{ \begin{matrix}{β}_{i} = {sin}^{- 1} ( - {\hat{t}}_{i , y} ) , & {α}_{i} = a tan 2 ( {\hat{t}}_{i , x} , {\hat{t}}_{i , z} ) \\ {β}_{i} = π - {sin}^{- 1} ( {\hat{t}}_{i , y} ) , & {α}_{i} = π + a tan 2 ( {\hat{t}}_{i , x} , {\hat{t}}_{i , z} )\end{matrix} \qquad ( 17 )$$

where a tan 2( [symbol] ) is the two-argument arctangent. The two solution branches arise because sin(⋅)=sin(π−⋅). The output of sin⁻¹(⋅) lies in [−π/2, π/2], so βᵢ can reach [−π/2, 3π2]. Similarly, a tan 2( [symbol] ) uses the signs of numerator and denominator to cover [−π, π] for αᵢ. To minimize servo motion at each control step, compare the current servo position

$$( {α}_{i}^{′} , {β}_{i}^{′} )$$

with all candidate solutions αᵢ+2kπ and βᵢ+2kπ for |k|≤nᵣ, k∈ [symbol] , and select the pair that minimizes

$$\vert {α}_{i}^{′} - {α}_{i} - 2 k π \vert and \vert {β}_{i}^{′} - {β}_{i} - 2 k π \vert$$

separately, where nᵣ constrains the maximum number of revolutions beyond one trigonometric period.

The minimum-norm thrust distribution achieves maximum thrust in any desired direction but can produce actuator configurations that cause flight instability. Two actuation deficiencies include: (a) inter-rotor downwash interference and (b) gimbal lock.

For inter-rotor interference, when the desired torque r=0, the thrust allocation yields co-linear thrust vectors tᵢ∥f for all i. If the desired force is along i_{B}, the inner servo positions become αᵢ=±/2 with βᵢ=0, so all four rotor systems point their downwash toward the opposing pair. This mutual interference invalidates the thrust model in (2) and reduces the effective thrust of the affected rotors.

For gimbal lock, if the desired force is along [symbol] with τ=0, the outer servo reaches βᵢ=±π/2, at which point cos βᵢ=0 and the inner servo αᵢ loses authority over the thrust direction. To illustrate the practical consequence, consider quadrotor 10 hovering at a π/2 roll angle so that f=[0 mg 0]^{T}. If the controller subsequently commands a small perturbation [ϵ mg 0]^{T} followed by [−ϵ mg 0]^{T} at high frequency, the computed αᵢ would oscillate between +π/2, saturating the servos and destabilizing flight. This singularity shares the same mathematical root as mapping elements of [symbol] ² to [symbol] ².

One can exploit the overactuation of quadrotor 10 to enable both enhancements through the null space of M. Because M∈ [symbol] ^{6×12} is a wide matrix, the linear system w=Mt is underdetermined. The general solution takes the form

t=M^{†}w+N_{M}c (18)

where N_{M} is the null-space basis of M (constant rank six) and c∈ [symbol] ⁶ is a coefficient vector that redistributes thrust among the rotors without changing the net wrench. The coefficients are chosen to satisfy two conditions: (i) adjacent rotor pairs must not have co-linear thrust vectors when f∥ [symbol] or f∥ [symbol] , to prevent downwash interference, and (ii) no individual thrust vector may be parallel to [symbol] , to avoid gimbal lock.

To satisfy condition (ii) and the second part of condition (i), set c₁=c₃=c₅= [symbol] f/∥f∥, [symbol] . This introduces a component that repels each inner servo position away from βᵢ=±π/2, proportionally to how close the desired force direction is to the gimbal-lock axis, i.e., [symbol] . For the first part of condition (i), tilt the rotor pair on top away from pointing directly at the bottom pair by setting

$$\{ \begin{matrix}{c}_{2} = - {c}_{4} = - ( f / ‖ f ‖ ) \cdot {i}_{ℬ} , {c}_{6} = 0 , & if ( f / ‖ f ‖ ) \cdot {i}_{ℬ} > 0 , \\ {c}_{2} = - {c}_{4} = 0 , {c}_{6} = - ( f / ‖ f ‖ ) \cdot {i}_{ℬ} , & if ( f / ‖ f ‖ ) \cdot {i}_{ℬ} \leq 0.\end{matrix} \qquad ( 19 )$$

This conditional assignment ensures that the anti-parallel null-space perturbation is applied to whichever rotor pair axis is most aligned with the body-frame x-direction, breaking the co-linearity that would otherwise cause direct downwash impingement.

In other words, the controller is configured to detect occurrence of a total force vector for the quadrotor being parallel with the longitudinal axis of the platform or the transverse axis of the platform and tilt at least one rotor system in each of the first rotor pair and the second rotor pair to advert co-linear thrust vectors in the first rotor pair and the second rotor pair. More specifically, the controller is configured to tilt each of the first rotor system, the second rotor system, the third rotor system and the fourth rotor system such that an individual thrust vector for each of the first rotor system, the second rotor system, the third rotor system and the fourth rotor system is not parallel with the longitudinal axis.

In summary, quadrotors control pipeline proceeds as follows: the geometric controller computes a desired six-dimensional wrench from SE tracking errors, disturbance adaption augments this wrench to reject disturbances, the thrust allocation decomposes the augmented wrench into individual rotor thrust vectors, and the null-space correction adjusts these vectors to avoid interrotor downwash interference and mechanical gimbal lock. The thrust vectors are then allocated to gimbal angles (αᵢ, βᵢ) and rotor speeds Ωᵢ through (17).

Example embodiments are provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below”, or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The terms “about” and “substantially” are intended to include the degree of error associated with measurement of the particular quantity based upon the equipment available at the time of filing the application. For example, “about” and “substantially” can include a range of ±8% of a given value.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A quadrotor comprising:
a body including a platform having a forward end, after end and two opposing sides extending between the forward end and the aft end, such that a longitudinal axis extend between the forward end and the after end, and a transverse axis extends between the two opposing side and perpendicular to the longitudinal axis;
a power source positioned on the platform;
a controller positioned on the platform and operationally connected to the power source;
a first rotor system positioned at the first side of the platform at the forward end and operatively connected to the controller and the power source;
a second rotor system positioned at the second side of the platform at the forward end and operatively connected to the controller and the power source;
a third rotor system positioned at the first side of the platform at the aft end and operatively connected to the controller and the power source, where the first rotor system and the third rotor system form a first rotor pair; and
a fourth rotor system positioned at the second side of the platform at the aft end and operatively connected to the controller and the power source, where the second rotor system and the fourth rotor system form a second rotor pair, wherein the controller is configured to articulate each of the first rotor system, the second rotor system, the third rotor system and the fourth rotor system about at least one axis independent of others of the first rotor system, the second rotor system, the third rotor system and the fourth rotor system;
wherein the controller is configured to detect a given rotor system in at least one of the first rotor pair or the second rotor pair that is articulated such that its thrust vector points directly along a thrust axis toward an opposing rotor system and, in response to detecting the given rotor pair, tilts the given rotor system away from the thrust axis.

2. The quadrotor according to claim 1 wherein the controller tilts the given rotor system at an angle between zero and forty-five degrees from the thrust axis.

3. The quadrotor according to claim 1 wherein the controller, in response to detecting the given rotor pair, redistributes thrust among the first rotor system, the second rotor system, the third rotor system and the fourth rotor system without changing a thrust vector of the quadrotor.

4. The quadrotor according to claim 1 wherein the controller is configured to detect occurrence of a total force vector for the quadrotor being parallel with the longitudinal axis of the platform or the transverse axis of the platform and tilt at least one rotor system in each of the first rotor pair and the second rotor pair to advert co-linear thrust vectors in the first rotor pair and the second rotor pair.

5. The quadrotor according to claim 1 wherein the controller is configured to tilt each of the first rotor system, the second rotor system, the third rotor system and the fourth rotor system such that an individual thrust vector for each of the first rotor system, the second rotor system, the third rotor system and the fourth rotor system is not parallel with the longitudinal axis.

6. The quadrotor according to claim 1, wherein the first rotor system includes a first rotor housing having a first support shaft that is articulable relative to the platform about a first axis, and a first rotor member mounted to the first rotor housing through a first rotor shaft, the first rotor shaft being articulable relative to the first rotor housing about a second axis that is substantially perpendicular relative to the first axis.

7. The quadrotor according to claim 6, wherein the first rotor member includes a first propeller connected to the first rotor shaft through a first motor and a second propeller connected to the first rotor shaft through a second motor the first motor driving the first propeller in a first direction and the second motor driving the second propeller in a second direction that is opposite the first direction.

8. The quadrotor according to claim 6, wherein the second rotor system includes a second rotor housing having a second support shaft that is articulable relative to the platform about the first axis, and a second rotor member mounted to the second rotor housing through a second rotor shaft, the second rotor shaft being articulable relative to the second rotor housing about a third axis that is substantially perpendicular relative to the first axis.

9. The quadrotor according to claim 8, wherein the third rotor system includes a third rotor housing having a third support shaft that is articulable relative to the platform about a fourth axis that is substantially parallel to the first axis, and a third rotor member mounted to the third rotor housing through a third rotor shaft, the third rotor shaft being articulable relative to the third rotor housing about a fifth axis that is substantially perpendicular relative to the fourth axis.

10. The quadrotor according to claim 9, wherein the fourth rotor system includes a fourth rotor housing having a fourth support shaft that is articulable relative to the platform about the fourth axis, and a fourth rotor member mounted to the fourth rotor housing through a fourth rotor shaft, the fourth rotor shaft being articulable relative to the fourth rotor housing about a seventh axis that is substantially perpendicular relative to the fourth axis.

11. The quadrotor according to claim 10, further comprising a first servo connecting the first support shaft with the platform and a second servo connecting the first rotor shaft with the first rotor housing.

12. The quadrotor according to claim 11, further comprising a third servo connecting the second support shaft with the platform and a fourth servo connecting the second rotor shaft with the second rotor housing.

13. The quadrotor according to claim 12, further comprising a fifth servo connecting the third support shaft with the platform and a sixth servo connecting the third rotor shaft with the third rotor housing.

14. The quadrotor according to claim 13, further comprising a seventh servo connecting the fourth support shaft with the platform and an eighth servo connecting the fourth rotor shaft with the fourth rotor housing.
